(19) United States
(12) Patent Application Publication
(10) Pub. No.: US 2006/0280582 A1
(43) Pub. Date: Dec. 14, 2006

(54) System for automatically capturing a fully loaded refuse container, and without any spillage, empty the contents of the refuse container into a refuse collection vehicle

(76) Inventor: Anthony S. Kouri, Runaway Bay, TX (US)

Correspondence Address: Anthony S. Kouri, 115 Harbor Drive # 2, Runaway Bay, TX, 76426, US

(21) Appl. No.: 11/150,701

(22) Filed: Jun. 13, 2005

(51) Int. Cl. B66C 1/00

(52) U.S. Cl. 414/408

(57) ABSTRACT

A mechanism or apparatus mounted on a refuse collection vehicle that is capable of reaching out from that vehicle and grasping a full refuse container, lifting the container vertically off the ground and transporting said container to the side of the refuse collection vehicle, rotating and inverting the container over the center of the refuse collection vehicle's collection hopper and empting the contents of the container into the collection hopper and returning the empty refuse container to the original location, all without spilling any of the contents of the refuse container anywhere other than in the collection hopper.

### BACKGROUND OF THE INVENTION

This invention relates to refuse collection vehicles of the type having an arm that carries refuse container grabbing mechanism that may extend from the body of the vehicle to grasp a refuse container, hoist it and dump its contents into the collection hopper of the vehicle body, and return the refuse container to its original position. Many of these refuse containers are overloaded by the end user and the refuse is stacked above the upper lip of the container creating a potential of spilling some of this refuse before the container has been transported to the refuse collection hopper, and more particularly to apparatus for preventing the arm and the refuse container from inadvertently drifting from a vertical orientation and causing the spillage of refuse in locations other than the refuse collection hopper.

Refuse collection vehicles are known which have an arm selectively extendible from the body of the vehicle and having grabbing or grasping apparatus at the end of the arm remote from the vehicle for clamping firmly about a refuse container. Associated with the arm is means for lifting the end of the arm including the grasping apparatus for dumping the contents of the container into a hopper at the top of the vehicle body. Such vehicles, known in the art as side loaders, have the obvious advantage in that only one person, to wit, a driver is necessary to collect refuse from a substantial number of dwellings or the like. The means for extending the arm includes a hydraulic drive cylinder with an extendible piston rod which permits the arm to be extended up to approximately 8 feet from the body so that a refuse container may be picked up in tight or difficult locations such as on the sidewalk of a street where the refuse vehicle may be prevented from getting close to the sidewalk because of parked vehicles and the like. The arm may be retracted fully so that the grasping apparatus is disposed substantially within the lateral confines of the body of the vehicle or in close proximity thereto thereby permitting the vehicle to be driven at highway speeds when necessary, such as when traveling to a dump site or the like.

A potential problem associated with the extendible lift arm is that which may occur should there be a failure to structurally support the extended arm and grasping apparatus and to provide a means to lift the grasped refuse container in a true vertical orientation and transporting the refuse container in the horizontal plane to the side of the vehicle body while maintaining the true vertical orientation, no mater the weight or size of the refuse container and contents.

Other extendible lift arm refuse vehicles utilize mechanisms which pivot or swing the arm relative to a fixed frame mounted on the vehicle. Here, there is no sliding carriage. Hydraulic cylinders act to extend and pivot the arm in an arc from the original container location to the dumping position. During this transition from grasp to dump the container is tipped prior to reaching the dumping position and if the container is fully loaded some spillage may occur. Still other vehicles, while using an extendable carriage, attach this carriage to the vehicle on a narrow support base thus allowing deflection of said base when under excessive load from a heavily loaded container thereby allowing the grasping apparatus to rotate creating the potential for some spillage to occur.

### SUMMARY OF THE INVENTION

Consequently, it is a primary object of the present invention to provide apparatus which precludes any of the contents of the refuse container becoming dislodged and spilling while being transported from its pick-up location to the refuse collection hopper on the refuse collection vehicle.

It is another object of the present invention to transport said refuse container in a vertical orientation from the pick-up location until the upper edge of the refuse container is slightly above and in close proximity to the flexible splash shield on the edge of the collection hopper and then pivoting the gripper assembly with the refuse container such that the opening of the refuse container is always over the refuse collection hopper of the refuse collection vehicle.

### BRIEF DESCRIPTION OF THE DRAWINGS

The particular features and advantages of the invention as well as other objects will become apparent from the following description taken in connection with the accompanying drawings in which:

FIG. 1. 1. Refuse collection vehicle cab. 2. Refuse container gripping arm assembly used to capture the refuse container. 3. Refuse collection hopper splash shields, shields that completely surround the hopper and form a funnel to feed the refuse into the refuse collection hopper. 4. Refuse collection hopper, the portion of the refuse body that holds the refuse prior to its compaction and ejection into the refuse transport body. 5. Refuse transport body the portion of the refuse vehicle used to transport the collected and compacted refuse to the landfill or refuse transfer station. 6. Tailgate hinge assembly, the pivot point between the tailgate and the refuse transport body. 7. Tailgate cylinder, a hydraulic cylinder used to elevate the tailgate. 8. Tailgate, used to retain the refuse until it is ready for discharge at the landfill or refuse transfer station. 9. Packer assembly, the portion of the refuse truck that compacts the refuse and transfers it to the transfer body. 10. Chassis frame, the structural members that connect the truck chassis to the refuse collection body.

FIG. 2. 11. Refuse hopper rear splash plate used to guide refuse from the collection container into the compaction hopper. 12. Refuse compaction hopper, where the collected refuse is compressed and ejected into the transport body. 13. Curb side flexible splash shield used to prevent refuse from falling out of the compaction hopper and protecting the collection containers from being damaged because of contact with the hopper wall. 14. Refuse collection body, allows the accumulation of a large quantity of compressed refuse to be transported from the collection locations to the landfill or transfer stations. 15. Street side hopper splash wall, to prevent refuse from being expelled over the compaction hopper and into the street. 16. Front hopper splash screen used to contain and control the refuse on its way from the collection container to the compaction hopper and permit the operator to observe the refuse transfer. 17. The packer mechanism, used to compress the collected refuse and transfer it to the refuse collection body. 18. Carriage guide channels, the tracks that guide the reach carriage and allow the carriage and container capture assembly to travel from the side of the collection body to the refuse collection container. 19. The reach carriage is the device used to transport the container capture assembly to the refuse container and return it to the refuse collection hopper. 20. The carriage rails, the rails that are part of the reach carriage and ride inside the carriage guide channels. 21. The gripper mechanism, the key component of the container capture assembly that allows the grasping of various sizes and shapes of refuse collection containers and hold them firmly enough to prevent their moving or escaping the grip yet not so firm as to deform or damage the container. 22. The elevator assembly provides a device to lift the gripper mechanism and the captured container vertically off the ground for transport to and from the refuse collection body. 23. The elevator guide tube prevents the elevator assembly from rotating or tilting when the refuse container is lifted into the transport position. 24. The dump mechanism provides a means of rotating the elevated refuse container from its vertical position at the side of the hopper to an inverted position over the hopper causing the refuse in the container to be ejected into the compaction hopper. 25. The dump pivot bushings are the center of rotation for the dump mechanism and prevent the refuse container from tilting toward the front or rear of the collection hopper during the dump cycle.

FIG. 3. 26. Gripper housing, a steel channel that contains the control apparatus for the grippers. 27. Gripper pivot pin, the axis upon which the gripper arms rotate. 28. Gripper arm. The curved arms used to capture the refuse container 29. Grip bumpers, a plurality of flexible bumpers that make contact with the refuse container and provide a firm hold on the container without damaging or marking the container. 30. Grip guide roller. A flexible roller at the ends of the gripper arms that guide off center or miss aligned containers into the center of the gripper arms without damaging or marking the container. 31. Grip cylinder. The hydraulic cylinder that closes and opens the gripper arms and controls the amount of force applied to the container. 32. Grasp adjustment slide, a mechanical control that is used to regulate the total travel of the gripper arms.

FIG. 4. 33. Hardened roller bearings, a plurality of roller bearings used to control the travel of the elevator assembly with a minimum of friction yet not permit any deviation in the elevators vertical travel. 34. Elevator cylinder, a hydraulic cylinder used to raise and lower the elevator assembly, the gripper assembly, and the refuse container. 35. Hardened wear strips, a hardened steel surface used as an interface between the elevator assembly and the roller bearings on the elevator tube.

FIG. 5. 36. Elevator transition block, an assembly that interfaces between the elevator tube and the dump cylinder and the dump bushings. 37. Dump cylinder mount, the connecting hardware that interfaces the dump cylinder to the reach carriage. 38. Elevator dump bumper, a flexible bumper to dampen any shock that might occur between the elevator assembly and the reach carriage.

FIG. 6. 39. Rear reach carriage bridge, a structural member that connects the two rails of the reach carriage. 40. Reach rail hardened roller, a roller to reduce friction between the reach carriage rails and the carriage assembly channels 41. Packer assembly roof, the top of the packer assembly housing and the mounting surface for the entire arm mechanism. 42. Reach cylinder mount, the hardware to connect the reach cylinder to packer assembly housing. 43. Reach cylinder rod, 44. Reach cylinder, the hydraulic cylinder that controls the travel of the reach carriage. 45. Front reach carriage bridge, a structural member that connects the two rails of the reach carriage.

### DESCRIPTION OF THE PREFERRED EMBODIMENT

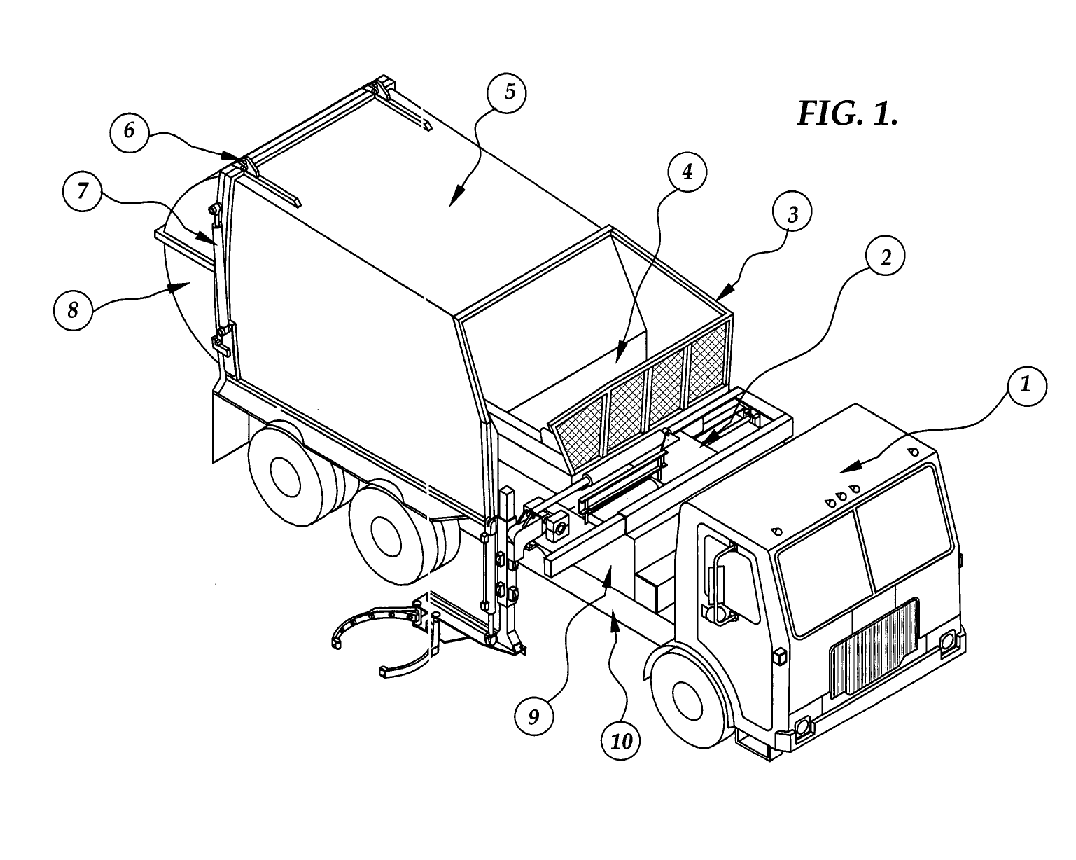

Referring now to the drawings FIG. 1. illustrates a side loading refuse vehicle conventionally having a cab 1 at the front, a chassis including longitudinally extending frame 10 and refuse body 5 mounted on the chassis behind the cab. The body has a refuse receiving hopper 4 that is surrounded by a splash shield 3 that guides the refuse into the hopper. The refuse is there compacted by a conventional apparatus 9 within the body and expelled out the rear end, preferably by dumping after the tailgate 8 is hinged 6 open by the hydraulically actuated cylinders 7.

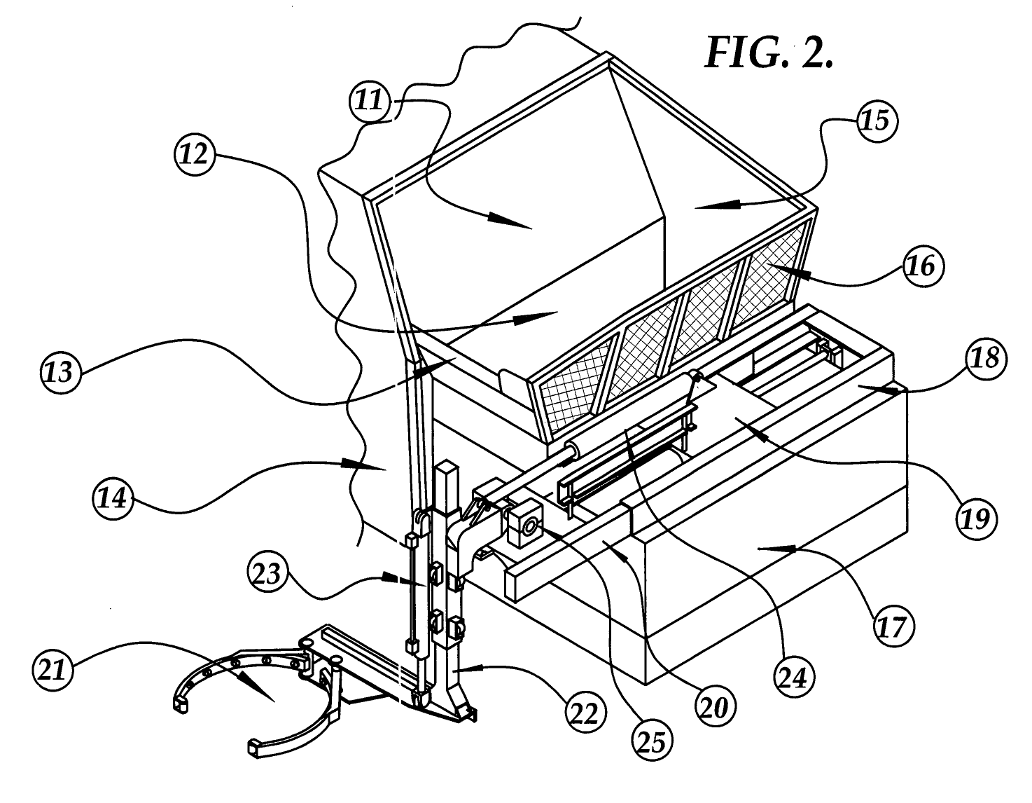

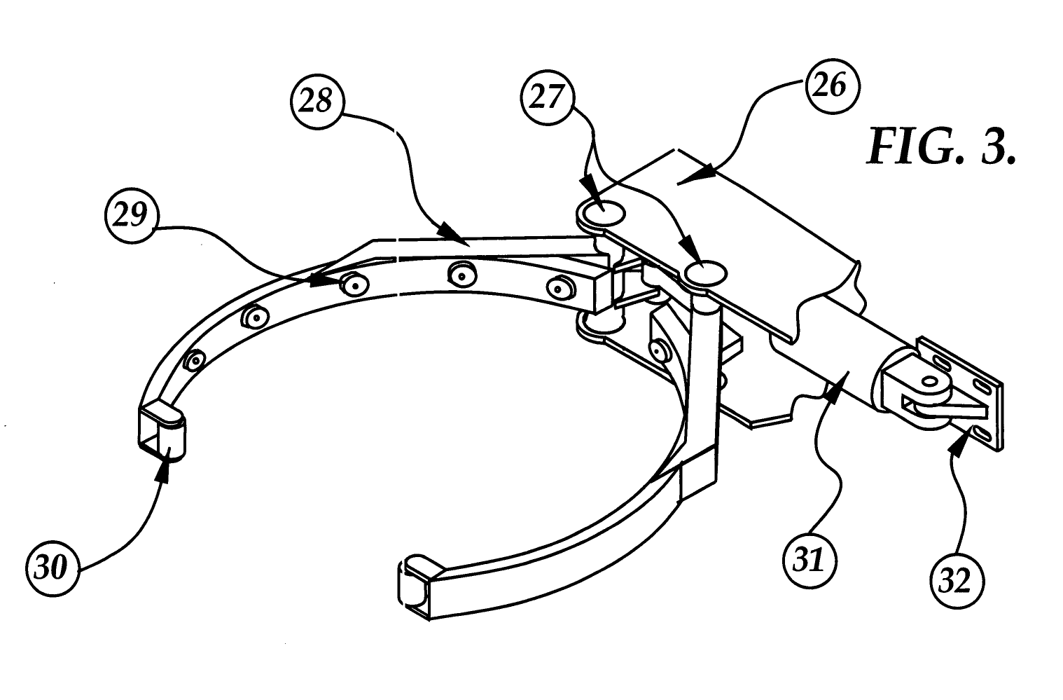

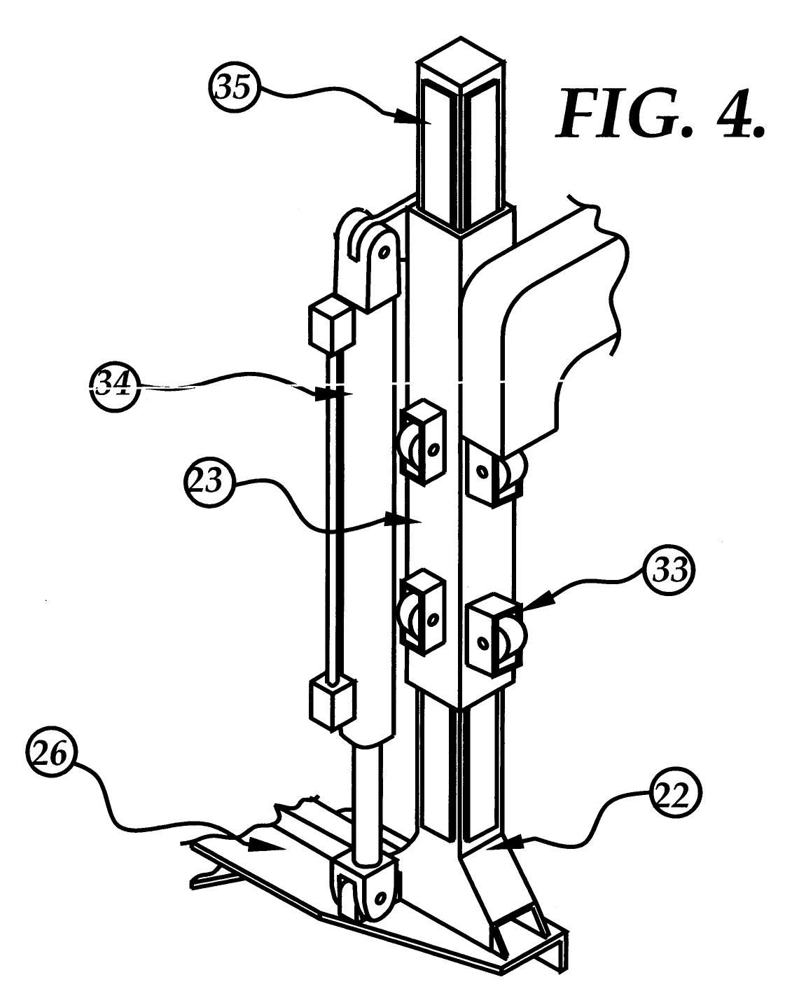

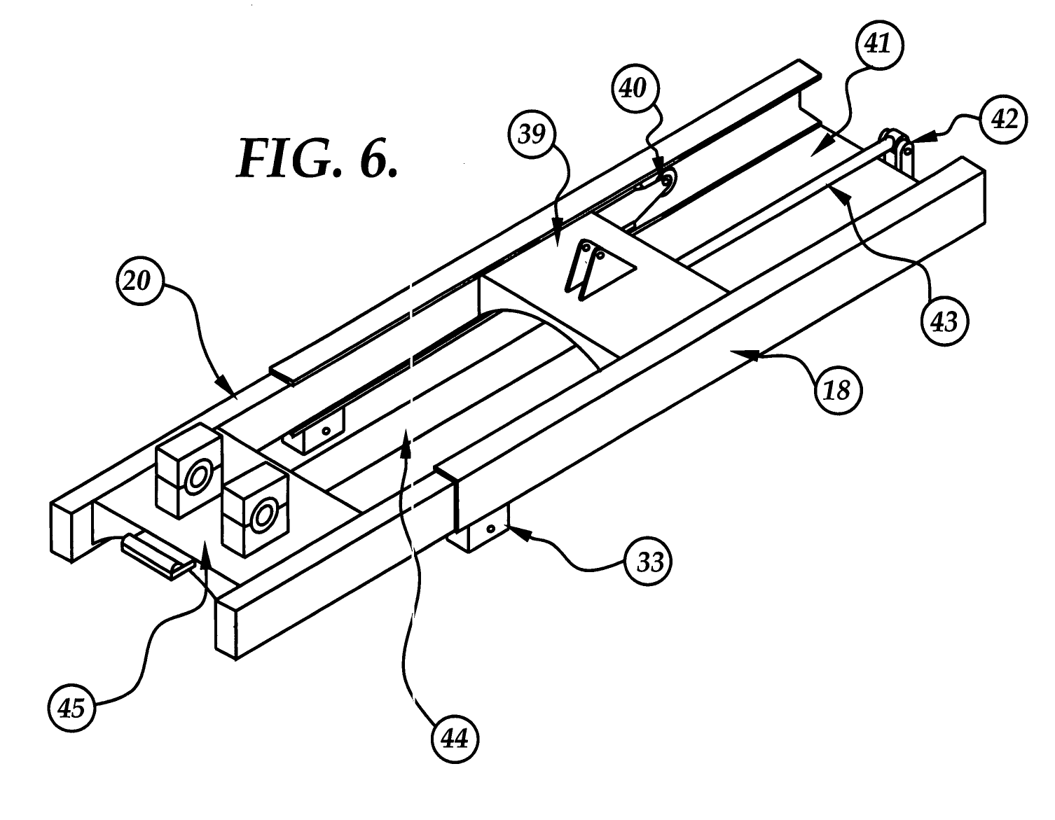

Upon arriving adjacent to a full refuse container the vehicle operator brings the vehicle to a complete stop and using controls mounted in the cab and monitoring the operation in the rear view mirrors or by means of a video camera mounted on the body and a video monitor mounted in the cab proceeds to position refuse container gripping arm assembly FIG. 1. 2 in close proximity to the refuse container. This positioning is accomplished by actuating the carriage reach hydraulic cylinder FIG. 6. 44 and transporting the carriage and gripper assemblies out away from the refuse body. This carriage assembly made up of two widely spaced carriage rails FIG. 2. 20 connected by to carriage bridges FIG. 6. 39, 45 traveling in the carriage channels supported by hardened rollers 40 attached to the rails and roller bearings 33 on the under side of the channels. The wide spacing of the rails and channels prevents the carriage assembly from rotating and keeps the gripper mechanism FIG. 2. 21 parallel to the chassis frame FIG. 1 10 and therefore parallel to the ground. After the gripper assembly has arrived at the container the operator activates the elevator hydraulic cylinder FIG. 4 34 to raise the gripper mechanism so that the gripper arms FIG. 3 28 will contact the refuse cart approximately ⅔ to ¾ up the side of the cart. The operator will now activate the grip hydraulic cylinder causing the grip arms to close, encircling the refuse container. If the refuse container is not precisely aligned with the gripper mechanism the grip guide roller FIG. 3. 30 will help rotate and center the refuse container within the gripper arms. As the gripper arms contract around the refuse container the plurality of grip bumpers FIG. 3. 29 come in contact with the container and provide a means of maintaining a firm, secure grip without damaging the refuse container.

After the capture of the refuse container the operator again activates the elevator hydraulic cylinder to raise the refuse container vertically off the ground. The vertical spacing of the plurality roller bearings FIG. 4. 33 on the elevator tube FIG. 4. 23 and the hardened wear strips FIG. 4. 35 on the elevator assembly FIG. 2. 22 insure that the elevator travels in a vertical direction. This vertical travel of elevator assembly and gripper mechanism with the captured refuse container maintains the absolute vertical orientation of the container thereby controlling the contents of container and preventing any spillage.

When the elevator has completed its lift of the refuse container the operator activates the carriage reach hydraulic cylinder to return the gripping arm assembly and the captured refuse container to the side of the refuse collection hopper. While in transit from above the original resting location to the side of the hopper the refuse container remains in its vertical orientation and any roughness in the travel has been eliminated by the carriage rail roller and the carriage channel roller bearing.

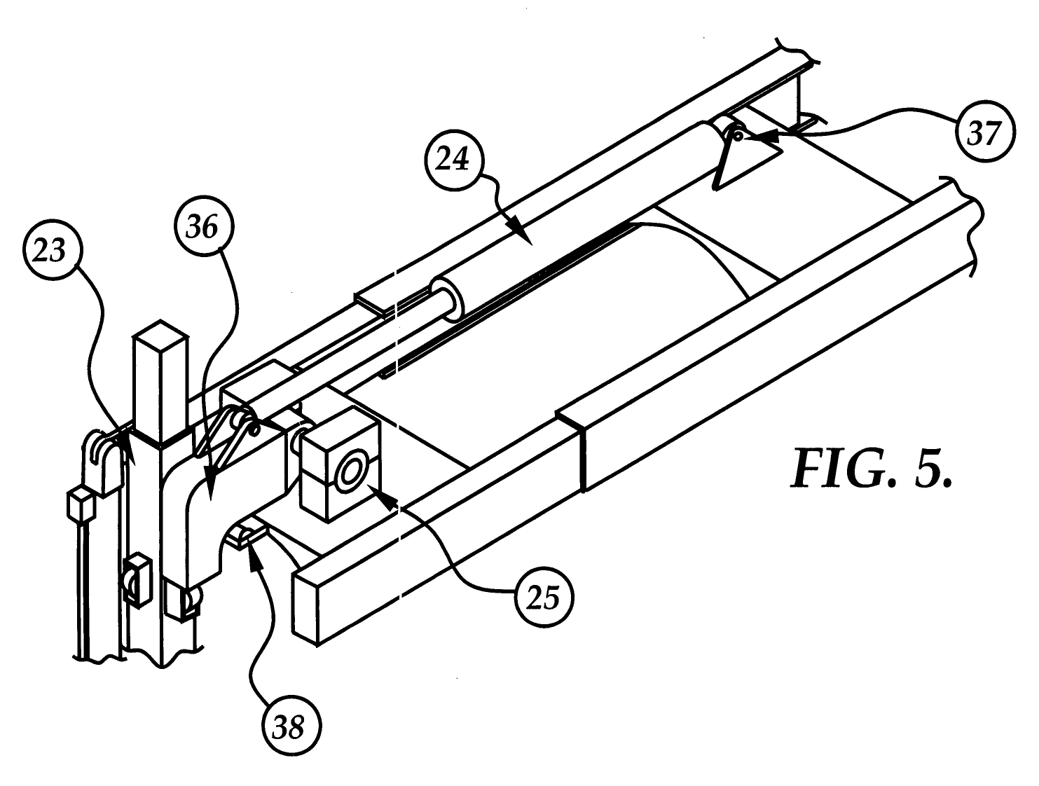

Once the refuse container has arrived at the side of the hopper the operator actuates the dump cycle which in turn activates the dump hydraulic cylinder FIG. 5. 24 which causes the elevator transition block FIG. 5. 36 to rotate in the dump pivot bushings FIG. 5. 25 which lifts and rotates the elevator assembly and gripper mechanism with the captured refuse container so that the refuse container is inverted over the center of the refuse collection hopper. The wide spacing and preciseness of the pivot bushings ensure that there is no tipping of the refuse container to the left or right and the container is accurately centered over the refuse collection hopper

After the refuse has been ejected from the refuse container the operator reverses the above sequence to return the empty refuse container to its original location and activates the packer assembly FIG. 1. 9 which hydraulically compacts the refuse in the collection hopper and transfers the refuse to the refuse transport body FIG. 1. 5. During the compaction and transfer cycle the operator advances the refuse collection vehicle to a location adjacent to the next full refuse container and repeats the above sequences.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

Having thus set forth the nature of the invention, what is claimed herein is:

1: A pair of curved, hydraulically actuated grippers provide a means of capturing various sizes and weights of refuse containers, even when they are not precisely orientated for capture, and grasping these containers securely in an upright position without spilling any of the contents.

2: A hydraulically operated vertical elevator mechanism lifts the gripper assembly, and the captured refuse container, vertically off the ground and holds it in an elevated position without allowing the refuse container to tip ether forward or backward, therefore preventing any spillage of the containers contents.

3: The vertical elevator mechanism permits the positioning of the gripper assembly at an elevated height prior to capture of the refuse container, this enables the capture of containers on raised platforms and loading docks without causing the containers to tin.

4: A twin horizontal rail and hydraulically actuated carriage system with a wide rail spacing to transport the elevated refuse container from the capture location to the side of the refuse collection vehicle while maintaining the container's vertical orientation and not permitting the container to tip in any direction, therefore preventing any spillage of the containers contents.

5: A container dumping apparatus mounted on the horizontal carriage system by means of two widely spaced pivot bearings and hydraulically actuated to rotate the vertical elevator, the container gripper assembly, and the captured refuse container in a forward direction toward the center of the refuse collection vehicle's collection hopper without allowing any tipping of the refuse container to ether side thereby empting the contents of the refuse container into the collection vehicle's hopper and preventing any spillage of the contents outside of said hopper.
